(19) United States
(12) Patent Application Publication
(10) Pub. No.: US 2003/0021443 A1
(43) Pub. Date: Jan. 30, 2003

(54) Embedding auxiliary data in a signal

(76) Inventors: Jaap Andre Haitsma, Eindhoven (NL); Antonius Adrianus Cornelis Maria Kalker, Eindhoven (NL); Alphons Antonius Maria Lambertus Bruekers, Eindhoven (NL); Minne Van Der Veen, Eindhoven (NL)

Correspondence Address: U.S. Philips Corporation, 580 White Plains Road, Tarrytown, NY, 10591, US

(21) Appl. No.: 10/201,662

(22) Filed: Jul. 23, 2002

(30) Foreign Application Priority Data
Jul. 27, 2001 (EP) 01202866.8

(51) Int. Cl. G06K 9/00; G06K 9/36; B42D 15/00

(52) U.S. Cl. 382/100; 382/232; 283/72

(57) ABSTRACT

This invention relates to a method and an arrangement for embedding auxiliary data in an information signal.

Only a part of a noise signal representing the auxiliary data is embedded but the complete noise signal may be detecting. This allows for a greater payload of the embedded signal.

The invention also relates to a corresponding method and arrangement for detecting auxiliary data in an information signal.

The invention relates to a method and an arrangement for embedding auxiliary data in an information signal, e.g. a video signal, an audio signal, or more generally, multimedia content. The invention also relates to a method and arrangement for detecting said auxiliary data and a device for recording and/or playing back an information signal.

The auxiliary data may e.g. be a digital watermark, which preferably (but not necessarily) is an imperceptible label that is embedded/added to an information/host signal e.g. comprising multimedia content, video, audio, etc. The label may contain for instance copyright information, the name of the owner of the material, rights for a user etc. The amount of information that may be stored in or derived on the basis of a watermark is usually referred to as a payload and is expressed in bits.

In most watermark schemes the watermark is a pseudo-random noise sequence (pn-sequence), which is added to a host signal/information signal in either the time, spatial or a transformed domain (e.g. Fourier, Discrete Cosine or Wavelet Domain). Watermark detection is then usually based on a correlation between the watermark and the embedded host signal. In this case we have a 1 bit payload for the watermark, i.e. the noise sequence is either present or it is not present.

In order to obtain a higher payload one option is to embed one noise sequence out of a set of predetermined noise sequences. During detection the host signal is correlated with all possible noise sequences of the set. For e.g. an 8-bit payload there is a need to correlate with 2ˆ 8=256 noise sequences. In this case the complexity of a detector grows exponentially with the number of bits of payload.

Patent specification U.S. Pat. No. 5,748,783 discloses embedding of multiple noise sequences in an information signal instead of embedding a single noise sequence. Each bit of the payload is associated with one noise sequence. A “1” bit may then be represented by adding the associated noise sequence to the host signal and a “O” bit may then be represented by refraining from adding or alternatively subtracting the noise sequence form the host signal. For an 8-bit payload there is only a need for correlating with noise sequences. The complexity of a detector grows linearly with the number of bits in the payload.

However, a drawback of this approach is that in practical watermark systems only a few noise sequences can be added to the host signal if reasonable robustness and imperceptibility are to be obtained thereby limiting the payload to only a few numbers of bits.

Patent specification WO 99/45705 (attorneys docket PHN 17.317), Kalker et al., discloses a method with a good trade-off between complexity and robustness/imperceptibility. The specification discloses to embed one noise sequence out of a set of noise sequences. However, the noise sequences consist only of cyclic shifted versions of one noise sequence. In order to retrieve the payload the host signal is correlated with the cyclic shifted versions of the noise sequence. For an 8-bit payload a noise sequence of length 256 is needed. An advantage of using cyclic shifted versions of one noise sequence is the fact that the correlation can be calculated in the Fourier domain using Fast Fourier Transforms (FFT). A limitation with respect to the size of the payload of the approach of Kalker et. al. is that quite of ten the size of the noise sequence is limited due to physical (e.g. image size) and/or perceptual reasons, see e.g. J. A. Haitsma and A. A. C. Kalker, A Fourier Domain Based Audio Watermarking Method, non pre-published PCT patent application EP01/00356 (attorneys docket PHNL000042). The patent specification WO 99/45705 is incorporated by reference in its entirety.

It is an object of the invention to provide a method and arrangement for embedding additional/auxiliary data in an information signal where the method and arrangement solves the problems of the prior art.

This is achieved by a method (and corresponding arrangement) of embedding auxiliary data in an information signal comprising the step of embedding a watermark signal W_{i,p}(K), where the samples of W_{i,p}(K) are selected according to auxiliary data (K) from a watermark signal Wᵢ, and where W_{i,p}(K) is indicative of the auxiliary data. The corresponding method (and corresponding arrangement) of detecting auxiliary data in an information signal comprises the steps of: detecting an embedded watermark signal (Wₚ), the samples of the embedded watermark signal (Wₚ) being selected from a watermark signal (Wᵢ), and where the watermark signal (Wₚ) is indicative of the auxiliary data (K); combining a predetermined signal (S) with the watermark (Wₚ) resulting in a first signal (Wₚ′); and determining the auxiliary data (K) on the basis of the first signal (Wₚ′). Preferred embodiments of the invention are defined in the sub claims.

Hereby, although only a part of a watermark/noise signal is embedded the complete watermark/noise signal may be detected/identified thereby allowing for a greater payload.

Additionally, the security of the watermark system is increased, since only a part of the total noise sequence is embedded in the host signal.

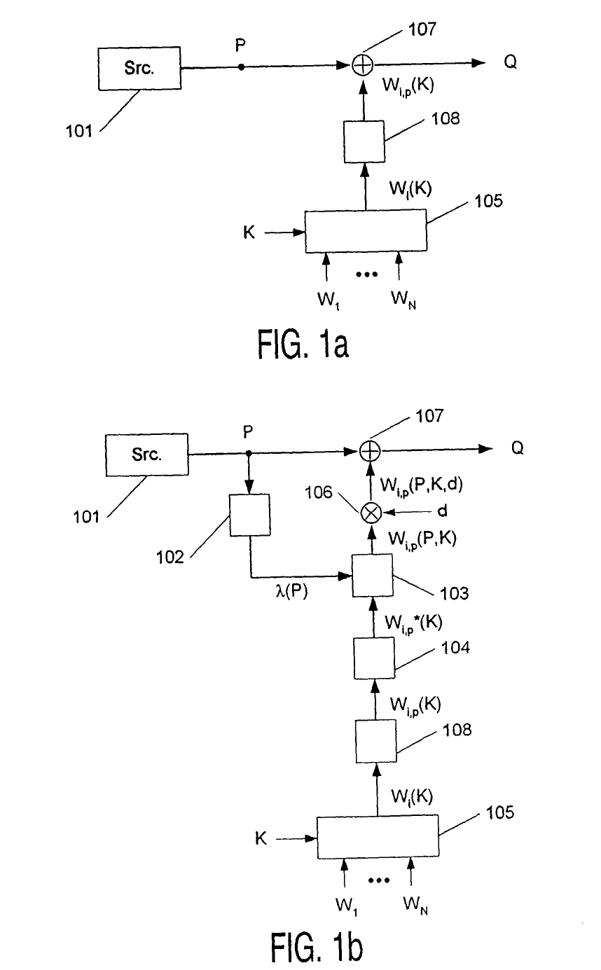

FIG. 1a shows an embodiment of an embedding arrangement according to the present invention;

FIG. 1b shows an alternative embodiment of an embedding arrangement;

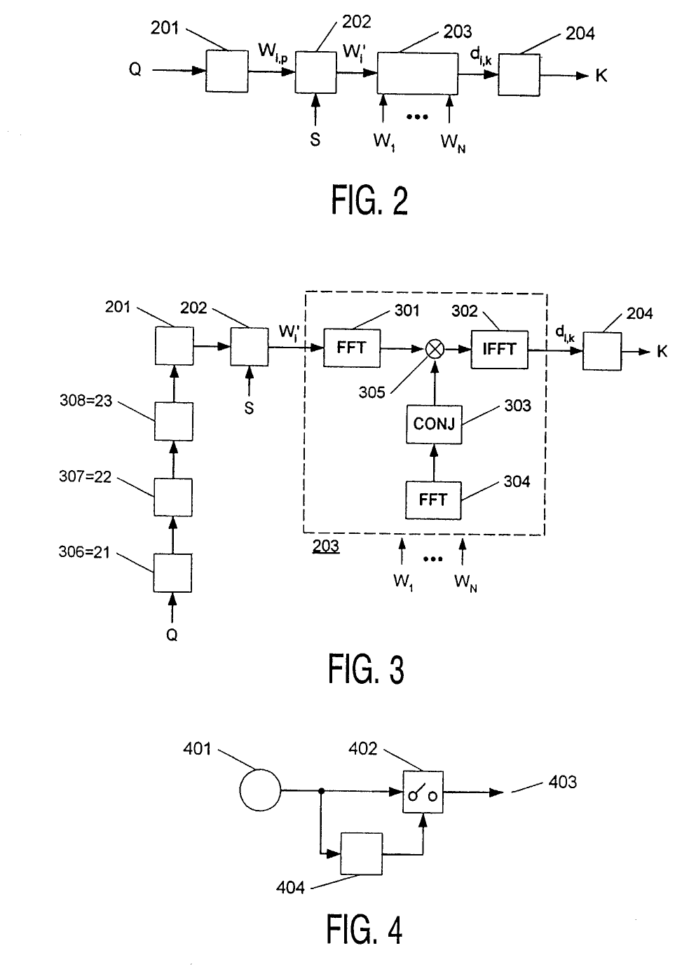

FIG. 2 illustrates a schematic diagram of a detector according to the present invention;

FIG. 3 illustrates an alternative embodiment of a detector according to the present invention;

FIG. 4 shows a device for recording and/or playing back an information multi-media bit stream with an embedded watermark.

For the sake of convenience the invention will be described as a system for embedding/attaching labels, preferably invisible to the human eye, to video content but the teachings can obviously be applied to any other contents including audio and multimedia. Additionally, an embodiment for detecting one or more labels is also described.

FIG. 1a shows an embodiment of an embedding arrangement according to the present invention. Shown is a source (101) that provides an information signal P to be embedded with auxiliary information/a watermark. The source may e.g. provide an image, an audio signal, a signal with multimedia content, etc. As an example used in the following the information signal P represents an image. Also shown is an adder (107), which adds a watermark W_{i,p} to the information signal/image P. The watermark W_{i,p} is preferably a random noise pattern having the same size as the image, e.g. N₁ pixels horizontally and N3 pixels vertically. As an alternative, the watermark W_{i,p} is preferably a random noise pattern having the same length as a part/frame of an audio signal.

An intermediate watermark W₁ (K) is generated/selected on the basis of a key/payload K and from a predetermined set of N watermarks W₁, . . . , W_{N} by first selection means (105). Each watermark W₁, i∈[1, . . . , N] represents the given key K to be retrieved at a receiving/detecting end. The set comprises N cyclic shifted versions W₁, . . . , W_{N} of a single watermark signal W (and thereby also the signal W itself) each having a size of N bits/samples. The key/payload is also N bits since each possible key is associated with a specific watermark from the set according to a given scheme, rule, etc.

As an example, the single watermark signal (W) consists of 1024 bits whereby the set consists of 1024 cyclic shifted versions (including W). The payload would then represent log 2(1024)=10 bits of information.

The first selection means (105) could e.g. comprise shift means (not shown) for shifting a stored or provided watermark (W) a given number of times depending on the provided key K that the specific shifted version represents. Alternatively, every shifted version may be stored and the key K may be used as an index for selecting the relevant version representing the key K.

Since the size of the noise sequence that may be embedded in the information signal P may be limited due to physical (e.g. image size) and/or perceptual reasons a part W_{i,p}(K), having a size of M samples, of the selected watermark W₁ (K) is selected by second selection means (108) where M samples is the amount of information that may be embedded fulfilling the restrictions. The selected part W_{i,p}(K) may e.g. be the first M samples of watermark W₁(K) or in general any part of watermark Wᵢ(K) having a length of M samples/bits. The part may e.g. be consecutive or comprise M arbitrary samples as long as this is done in the same way for an encoder and corresponding decoder, e.g. by selecting every 4^{th} sample, combining a number of separate parts of equal or different size, etc.

As an example it may only be possible to embed a watermark of e.g. M=256 samples in the information signal due to restrictions like the ones mentioned above. Then a consecutive part having a length of 256 bits/samples would be selected from the given selected cyclic shifted version of e.g. 1024 bits/samples.

As a preferred alternative, an intermediate watermark Wᵢ (K) may be embedded using a single noise-sequence comprising a number N bits/samples as input and selecting a specific bit/sample as a starting point depending on the key/payload (K), e.g. by the first selection means (105) and then selecting a part W_{i,p}(K) of the watermark Wᵢ (K), e.g. by the second selection means (106), having the length of M samples/bits, e.g. due to restrictions like described above, starting from the specific bit/sample selected as a starting point. If M is larger than the number of samples between the starting point and the last sample then cyclic wrap-around is used, i.e. the first sample is ‘seen’ as being next to the last and vice versa. The payload would represent log 2(N) bits as there are N starting points.

The selected watermark part W_{i,p}(K) is added by the adder (107) to the information signal P, like described above, resulting in a watermarked/host signal Q ‘carrying’ a payload of N bits using proper detection as describe later.

Alternatively, the function of the first selection (105) and the second selection means (108) may be integrated in suitable means so that a relevant part W_{i,p}(K) of a relevant cyclic shifted version Wᵢ (K) may be generated/selected in one go.

FIG. 1b shows an alternative embodiment of an embedding arrangement. The embodiment corresponds to the embodiment in FIG. 1a with the exception of elements (102, 103, 104 and 106), which will be explained in the following.

Preferably, a 2D watermark W_{i,p}* (K) having the size of a complete image P is generated at (104) by repeating and, if necessary, truncating smaller watermark units/tiles, each comprising the relevant part W_{i,p}(K) of a selected/generated relevant cyclic shifted version Wᵢ (K), over the extent of the image, as described in Kalker et al., so that a watermark detection process does not have to search for a watermark over the entire image space (N₁×N₂) but only over a space equal to the fixed size of a unit/tile e.g. M₁×M₂, where M₁ preferably is equal M₂.

Additionally, a local depth map/visibility mask λ (P) is generated/derived (102). The depth map λ.(P) provides for each pixel position of the image P a measure for the visibility of additive noise. The watermark W_{i,p}* (K) are modulated (103) at pixel-level with the depth map, i.e. each pixel of W_{i,p}* (K) are multiplied with the respective depth map value for that particular pixel resulting in a noise sequence W_{i,p}(P,K) being dependent of the image P and the key K. Preferably, the depth map or visibility mask λ (P) is derived so as to have an average value of 1.

Finally, the strength of the final watermark is determined by a global depth parameter d, which provides a globing scaling (106) of W_{i,p}(P,K) resulting in a scaled watermark W_{i,p}(P,K,d), which is added (107) to the image P, e.g. rounding to integer pixel values and/or clipping to an allowed pixel value range, resulting in a watermarked image Q. A large and small value of d corresponds to a robust and possible visible watermark and a weak but almost/substantially imperceptible watermark, respectively. This may also be adapted for a ID signal where a ID watermark W_{i,p}* (K) having the length of a frame is generated at (104) by repeating and, if necessary, truncating smaller watermark units, each comprising the relevant part W_{i,p}(K) of a selected/generated relevant cyclic shifted version Wᵢ. (K), over the extent of the frame.

FIG. 2 illustrates a schematic diagram of a detector according to the present invention. Shown is an information/host signal Q, which as an example represents an image/that possible contains auxiliary data/a watermark to be detected. A sample/frame W_{i,p} of a given length M is extracted/retrieved from the information/host signal Q. A predetermined signal S is merged, concatenated, extended or combined (202) with/to the watermark W_{i,p} resulting in a first signal Wᵢ′. Preferably, the predetermined signal S is a signal consisting only of zero bit values and having a length of N−M, where N is the length of a cyclic shifted version of a watermark (which only a part of is embedded in a host/information signal) and M is the length of the sample W_{i,p}. It does not matter how S is extended, merged, concatenated, combined etc. as long as it is done in the same way in the encoder and decoder. As an example, the signal W_{i,p}(K) is a contiguous segment of a periodically version of the watermark signal W₁, i.e. W_{i,p}(K) may be of the form W₁[i₀+k], where iₒ is a given starting point, k ranges over a contiguous segment of index values and where cyclic wrap-around is used. Alternatively, the samples of W_{i,p}(K) are selected from the watermark signal Wᵢ by selecting a number of samples starting from a given starting point (i₀) and skipping with a sub-sampling factor (d) using cyclic wrap-around, i.e. W_{i,p}(K) may be of the form W₁[i₀+k*d], the given starting point (i₀), the sub-sampling factor (d) and the watermark signal index (i) indicating a given value of the auxiliary data (K). The decoder should then be arranged accordingly, whereby the tuple (i₀, i) or the triple (i₀, d, i) is indicating a given value of the auxiliary data (K) for using a starting point and using a starting point and sub-sampling, respectively, for indicating the auxiliary data (K). Additionally, if sub-sampling Wᵢ with (d) is used, then the combining method can be taken as padding with (d-1) zeros between consecutive samples of Wₚ (and possibly extending with zeros). The second method (i,i0,d) is a generalised method of the first (i,i0).

The first signal W₁′ is then correlated (203) with every possible cyclic shifted version Wᵢ, iε[1, . . . , N] belonging to a set of cyclic shifted versions Wᵢ, . . . , W_{N} of a single watermark signal W equal to the set described above in connection with embedding. This may e.g. be done by having each cyclic shifted version stored or having stored one version and cyclically correlating with the first signal Wᵢ′. The correlation (203) results in N correlation values d_{i,k}, iε[1, . . . , N], i.e. one for each possible embedded noise signal. A correlation value above a given threshold signifies that a particular noise signal is present in a frame of the information signal Q. Since only a part of a watermark/noise signal is embedded the correlation value for that signal would be smaller that if the complete signal was embedded. However, a correlation value may still be calculated by using the first signal Wᵢ′, where the correlation value is discernable from the correlation values of non-present watermarks/noise signals.

Computing the correlation of between a sample, frame, part etc. W′ of an information signal Q and a particular watermark W may e.g. comprise computing the inner product dₖ=<W′, W> for the information signal values and the corresponding values of the watermark pattern/noise signal. For a one-dimensional watermark and information signal, e.g. an audio signal, with a sample length of N the inner product may be given by:

$${d}_{k} = \frac{1}{N} {\sum }_{n = 1}^{N} {w}_{n}^{′} {w}_{n} ,$$

For a two-dimensional watermark and information signal, e.g. a image, having the size Ni×N2 the inner product may be described by:

$${d}_{k} = \frac{1}{{N}_{1} {N}_{2}} {\sum }_{k = 1}^{{N}_{1}} {\sum }_{l = 1}^{{N}_{2}} {W}_{k l}^{′} {W}_{k l} ,$$

A brute force method of obtaining a correlation value between the first signal Wᵢ′ and each possible embedded watermark of the set Wᵢ, . . . , W_{N} requires a calculation of N correlation values dₖ.

The N calculated correlation values d_{i,k,} iε[1, . . . , N] is compared to a predetermined threshold by an evaluation circuit (204) in order to determine the correlation value(s), if any, that is/are above the threshold thereby signifying that the corresponding watermark is present in the information signal Q. The determined watermark is directly indicative of the payload/auxiliary data K when the watermark has been embedded like described earlier in connection with FIGS. 1a and 1b.

As an example, say that a specific cyclic shifted version of a watermark, e.g. number 32, shifted 32 times, starting with sample/bit 32, etc. according to a predetermined scheme, out of a set of 1024 versions has been embedded according to FIGS. 1a and 1b in an information signal P. This signifies that the payload/the auxiliary data has the value 32. Due to restrictions, it is only possible to embed 256 samples of the total of 1024 samples of the specific cyclic version. The detector according to the present invention would then take a sub-part, frame, etc. of 256 samples of the information signal with an embedded watermark and concatenate a first signal of 1024-256=768 zeros to the sub-part and then calculate 1024 correlation values, one for each possible cyclic shifted version of the set. The correlation value for the specific cyclic version would be above the threshold thereby determining, which particular version was embedded and obtaining the number, i.e. 32 in this example, and thereby obtaining the value of the payload. In this way log 2(1024) bits of information for a payload may be derived although only 256 samples actually are embedded. The embedding of M samples instead N samples extends the payload at the cost of smaller correlation values for a present watermark, so practically M has to have a given size in relation to N.

Alternatively, the N correlation values may be calculated simultaneously since each possible watermark pattern is cyclic shifted versions of the other using the Fast Fourier Transform (FFT) as shown in FIG. 3. The first signal Wᵢ′ the possible embedded watermarks of the set W₁, . . . , W_{N} are subjected to FFT in transform circuits (301) and (304), respectively. These operations gives:

ŵᵢ′=FFT(Wᵢ′ and

Ŝet=FFT(W₁, . . . , W_{N}),

Computing the correlation is similar to computing the A convolution of Wᵢ′ and the conjugate of Ŝet, which in the transform domain corresponds to:

\hat{d}ₖ=Ŵᵢ\mathring{x}conj(Ŝet)

where \mathring{x} denotes point wise multiplication and conj ( . . . ) denotes inverting the sign of the imaginary part of the argument. A conjugation circuit (303) perform the A conjugation of Ŝet and the point wise multiplication is carried out by a multiplier (305). The set of correlation values dₖ is then obtained by applying inverse Fourier transforming the result of the multiplication:

d=IFFT(dₖ),

which is performed by an inverse FFT circuit (302). Like described above a watermark pattern (any of Wᵢ, . . . , W_{N}) is 12 detected to be present if a correlation value dk is larger than a given threshold.

A further advantageously embodiment is also shown in FIG. 3 where watermark detection is not done for each frame/sample but for groups of frames/samples. By accumulating (306) a number of frames the statistics of detection is improved and therefore also the reliability of detection, which is especially advantageous since the value of correlation values for a present watermark is 10 less since only a part of the noise signal/watermark actually is embedded. The accumulated frames are subsequently partitioned (307) into blocks of suitable size, e.g. and all the blocks are stacked (308) in a buffer of size M₁×M₂, where M₁ preferably is equal M₂ (and preferably equal to the size of the tiles/units used in one embodiment during embedding). For a ID signal M₁=1 and M₂=length of a given frame. The buffer is then used as input to (201). Alternatively, (306, 307, 308) may be used between (202) and (203). Blocks (306-308) and/or (301-305) may be implemented independently in connection with a detector according the invention, i.e. either blocks (306-308) or (301-305) may be implemented or both. If the blocks (306-308) are used then the calculated correlation values dk is not calculated on the basis of the complete image Q but only a part/a tile.

The embedded information may identify, for example, the copy-right holder, a description of the content and/or rights associated with the use of the content. In DVD copy-protection it would allow material to be labeled as ‘copy once’, ‘ever copy’, ‘copy no more’, etc. FIG. 4 shows a device, e.g. a DVD player, for recording and/or playing back an MPEG encoded bit stream with an embedded watermark. The bit stream is recorded/stored on a information medium like a DVD disc 401. The recorded signal is applied to an output terminal 403 via a switch 402. The output terminal 403 is connected to an external MPEG decoder and display device (not shown). It is assumed that the DVD player may not play back video signals with a predetermined embedded watermark, unless other conditions are fulfilled which are not relevant to the present invention. Alternatively, the quality of the played back audio and/or video may be degraded. For example, watermarked signals may only be played back if the medium 401 includes a so-called “wobble” key. In order to detect the watermark, the DVD player comprises a watermark detector 404 as described above. The detector receives the recorded signal and controls the switch 403 in response to whether or not the watermark is detected and/or what the value of the auxiliary data/the payload signifies.

1. A method of embedding auxiliary data (K) in an information signal (P) comprising the step of:
embedding a watermark signal W_{i,p}(K), where the samples of W_{i,p}(K) are selected according to auxiliary data (K) from a watermark signal Wᵢ, and where W_{i,p}(K) is indicative of the auxiliary data (K).

2. A method according to claim 1, wherein the signal W_{i,p}(K) is a contiguous segment of a cyclically extended version of the watermark signal Wᵢ.

3. A method according to claim 1, wherein the signal W_{i,p}(K) is a contiguous segment of a periodically sub-sampled version of the watermark signal Wᵢ.

4. A Method according to claims 1-3 wherein Wᵢ is selected from a set of pre-determined watermark signals {Wₗ, . . . , W_{N}}, where N may be equal to 1, and where the selection of a given watermark signal Wᵢ indicates a set of given values of the auxiliary data (K).

5. A method according to claim 1 or 2, where the samples of W_{i,p}(K) are selected from the watermark signal Wᵢ by selecting a number of samples starting from a given starting point using cyclic wrap-around, the given starting point and the watermark signal index (i) indicating a given value of the auxiliary data (K).

6. A method according to claim 1 or 3 where the samples of W_{i,p}(K) are selected from the watermark signal Wᵢ by selecting a number of samples starting from a given starting point (i₀) and skipping with a sub-sampling factor (d) using cyclic wrap-around, the given starting point (i₀), the sub-sampling factor (d) and the watermark signal index (i) indicating a given value of the auxiliary data (K).

7. A method according to claims 1-6, where the length of the signal W_{i,p}(K) is smaller than or equal to the length of the watermark signal Wₗ.

8. A method of detecting auxiliary data (K) in an information signal (Q), comprising the steps of:
detecting an embedded watermark signal (Wₚ), the samples of the embedded watermark signal (Wₚ) being selected from a watermark signal (Wᵢ), and where the watermark signal (Wₚ) is indicative of the auxiliary data (K),
combining a predetermined signal (S) with the watermark (Wₚ) resulting in a first signal (Wₚ′), and
determining the auxiliary data (K) on the basis of the first signal (Wₚ′).

9. A method according to claim 8, where
the watermark signal (Wᵢ) is selected among a set of pre-determined watermark signals (Wₗ, . . . , W_{N}), where N may be equal to 1, and the selection of a given watermark signal Wᵢ indicates a set of given values of the auxiliary data (K),
the step of determining the auxiliary data (K) is done by correlating the first signal (Wₚ′) and each signal in the predetermined set (Wₗ, . . . , W_{N}),
and where a correlation value (d_{i,k}) above a predetermined threshold value indicates that a corresponding part (Wₚ) of a signal in (Wₗ, . . . , W_{N}) is embedded in said information signal (P).

10. A method according to claim 8, where
the samples of W_{i,p}(K) are selected from the watermark signal Wᵢ by selecting cyclically contiguous samples starting from a given starting point (i₀), where the tuple (i₀, i) is indicating a given value of the auxiliary data (K), and
where the step of determining the auxiliary data (K) comprises cyclic correlation of the first signal (Wₚ′) and the watermark signal Wₗ.

11. A method according to claim 8, where
the samples of W_{i,p}(K) are selected from the watermark signal Wᵢ by selecting samples starting from a given starting point (i₀) and cyclically skipping with a factor (d), where (d) may be equal to 1, where the triple (i₀,d,i) is indicating a given value of the auxiliary data (K), and
where the step of determining the auxiliary data (K) comprises cyclic correlation of the first signal (Wₚ′) and the watermark signal Wᵢ.

12. A method according to claims 9-11 wherein the step of correlating comprises:
Fast Fourier Transform (FFT) of said first signal (Wₚ′) resulting in a first FFT signal and of said predetermined set of watermark signals (Wₗ, . . . W_{N}) or every cyclic shifted version of the watermark signal Wᵢ resulting in a set of second FFT signals,
point-wise multiplication of the first FFT signal and a conjugate of the second FFT signals resulting in a set of third FFT signals, and
inverse Fast Fourier Transform (FFT) of the third set of FFT signals.

13. An arrangement for embedding auxiliary data (K) in an information signal (P) comprising:
means (105) for selecting a watermark signal W_{i,p}(K), where the samples of W_{i,p}(K) are selected according to auxiliary data (K) from a watermark signal Wᵢ, and
means for embedding (107, 108) the watermark signal W_{i,p}(K) in said information signal (P) where W_{i,p}(K) is indicative of the auxiliary data (K).

14. An arrangement for detecting auxiliary data (K) in an information signal (Q), comprising:
means (201, 203) for detecting an embedded watermark signal (Wₚ), the samples of the embedded watermark signal (Wₚ) being selected from a watermark signal (Wₗ), and where the watermark signal (Wₚ) is indicative of the auxiliary data (K),
means (202) for combining a predetermined signal (S) with the watermark (Wₚ) resulting in a first signal (Wₚ′, and
means (204) for determining the auxiliary data (K) on the basis of the first signal (Wₚ′).

15. A device for recording and/or playing back an information signal, the device comprising means (402) for influencing recording and/or playback of the information signal in dependence upon auxiliary data embedded in said information signal wherein the device further comprises an arrangement (404) for detecting said auxiliary data (K) according to claim 11.

16. A device for transmitting an information signal, the device comprising an arrangement for embedding a watermark in the information signal, the arrangement comprising:
means (105) for selecting a watermark signal W_{i,p}(K), where the samples of W_{i,p}(K) are selected according to auxiliary data (K) from a watermark signal Wᵢ,
means for embedding (107, 108) the watermark signal W_{i,p}(K) in said information signal (P) where W_{i,p}(K) is indicative of the auxiliary data (K).

17. An information signal (P) with auxiliary data (K) in the form of an embedded watermark (W_{i,p}), the samples of W_{i,p}(K) being selected according to the auxiliary data (K) from a watermark signal Wᵢ, and where W_{i,p}(K) is indicative of the auxiliary data (K).

18. A storage medium (401) having stored thereon an information signal (P) with auxiliary data (K) in the form of an embedded watermark (W_{i,p}), the samples of W_{i,p}(K) being selected according to the auxiliary data (K) from a watermark signal Wᵢ, and where W_{i,p}(K) is indicative of the auxiliary data (K).
